(19) United States
(12) Patent Application Publication
(10) Pub. No.: US 2023/0044712 A1
(43) Pub. Date: Feb. 9, 2023

(54) DISTANCE MEASUREMENT SYSTEM, DISTANCE MEASUREMENT DEVICE, AND DISTANCE MEASUREMENT METHOD

(71) Applicant: Hitachi-LG Data Storage, Inc., Tokyo (JP)

(72) Inventors: Katsumi ITO, Tokyo (JP); Katsuhiko IZUMI, Tokyo (JP); Hisataka SUGIYAMA, Tokyo (JP)

(21) Appl. No.: 17/868,169

(22) Filed: Jul. 19, 2022

(30) Foreign Application Priority Data
Aug. 6, 2021 (JP) 2021-129994

(51) Int. Cl. G01S 17/894; G01S 17/10

(52) U.S. Cl. CPC G01S 17/894; G01S 17/10

(57) ABSTRACT

A distance measurement system includes a distance measurement device and an external processing device. Here, the distance measurement device receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period. The external processing device acquires the measured distance from the distance measurement device and performs data processing. Then, the external processing device predicts a measured distance including a distance error caused by an influence of multipath. The external processing device generates a correction expression for correcting the measured distance. The external processing device corrects the measured distance acquired from the distance measurement device using the correction expression.

### CROSS-REFERENCE TO RELATED APPLICATION

The present application claims priority from Japanese application JP 2021-129994, filed on Aug. 6, 2021, the contents of which is hereby incorporated by reference into this application.

### BACKGROUND OF THE INVENTION

### 1. Field of the Invention

The present invention relates to a distance measurement system, a distance measurement device, and a distance measurement method.

### 2. Description of the Related Art

In the related art, it is known that a distance error may occur when a distance to an object is measured using a distance measurement device. Here, WO 2017/150246 A discloses a technique that achieves three-dimensional detection, measurement, display, or depiction which has high detection accuracy or high measurement accuracy and whose accuracy does not depend on environmental illuminance.

That is, WO 2017/150246 A discloses a technique in which, when the sum of the amount of exposure a0 by a first exposure signal is A0, the sum of the amount of exposure a1 by a second exposure signal is A1, and the sum of the amount of exposure a2 by a third exposure signal is A2, a signal processing unit determines the magnitude relationship between A0 and A2 for each pixel and performs calculation of Expressions 3 and 5 according to the determination results (Expressions 2 and 4) to calculate the distance to a subject.

It is generally known that, in an environment in which a material having high reflectance is used for walls, floors, and the like, unnecessary reflections from the walls, the floors, and the like cause a multipath phenomenon in which the length of an optical path seems to be large. Therefore, in a case in which distance measurement is performed by measuring the time until emission light (for example, infrared rays) emitted from a laser is reflected by an object and returned to a light receiving element (that is, in a case in which distance measurement based on time of flight known as TOF is performed), in an environment that is strongly affected by multipath, there is a problem that a distance error occurs because the distance measured by the TOF is longer than the actual distance to the object to be measured.

However, it is considered that the technique disclosed in WO 2017/150246 A does not sufficiently respond to the occurrence of the distance error caused by the influence of the multipath.

### SUMMARY OF THE INVENTION

Therefore, an object of the invention is to provide a distance measurement system, a distance measurement device, and a distance measurement method that check the influence of multipath, correct a distance for each pixel to suppress an error from an actual distance, and improve the accuracy of the distance.

According to a first aspect of the invention, the following distance measurement system is provided. That is, the distance measurement system includes a distance measurement device and an external processing device. The distance measurement device receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period. The external processing device acquires the measured distance from the distance measurement device and performs data processing. The external processing device predicts a measured distance including a distance error caused by an influence of multipath, generates a correction expression for correcting the measured distance, and corrects the measured distance acquired from the distance measurement device using the correction expression.

According to a second aspect of the invention, the following distance measurement device is provided. That is, the distance measurement device receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period. Then, the distance measurement device predicts a measured distance including a distance error caused by an influence of multipath, generates a correction expression for correcting the measured distance, and corrects the measured distance using the correction expression.

According to a third aspect of the invention, the following distance measurement method is provided. That is, the distance measurement method is a method using a distance measurement device that receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period. The distance measurement method includes: predicting a measured distance including a distance error caused by an influence of multipath; generating a correction expression for correcting the measured distance; and correcting the measured distance using the correction expression.

According to the invention, it is possible to provide a distance measurement system, a distance measurement device, and a distance measurement method that check the influence of multipath, correct a distance for each pixel to suppress an error from an actual distance, and improve the accuracy of the distance.

### BRIEF DESCRIPTION OF THE DRAWINGS

FIG. 1 is a block diagram illustrating an example of a configuration of a distance measurement system;

FIG. 2 is a diagram illustrating an example of the calculation of a distance by a TOF camera;

FIG. 3 is a diagram illustrating Numerical Expression 1 and Numerical Expression 2;

FIG. 4 is a diagram illustrating a difference in measured distance between measurement in an ideal state and measurement including an influence of multipath;

FIG. 5 is a diagram illustrating an example of the influence of the multipath indoors;

FIG. 6 is a diagram illustrating an example of a correction process flow;

FIG. 7 is a diagram illustrating an example of a method for acquiring an amount of charge;

FIG. 8 is a diagram illustrating a ratio between the amounts of charge under ideal conditions;

FIG. 9 is a diagram illustrating the ratio between the amounts of charge in a case in which the influence of the multipath is small;

FIG. 10 is a diagram illustrating the ratio between the amounts of charge in a case in which the influence of the multipath is large;

FIG. 11 is a diagram illustrating an example of a method for calculating a relational expression of a distance error;

FIG. 12 is a diagram illustrating an example of the method for calculating the relational expression of the distance error;

FIG. 13 is a diagram illustrating an example of the method for calculating the relational expression of the distance error;

FIG. 14 is a diagram illustrating a distance error at a position of ½ L;

FIG. 15 is a diagram illustrating an example of how to calculate a correction expression;

FIG. 16 is a diagram illustrating an example of the effect of a correction operation; and

FIG. 17 is a diagram illustrating an example of how to calculate the correction expression using a method different from that according to this embodiment.

### DETAILED DESCRIPTION OF THE PREFERRED EMBODIMENTS

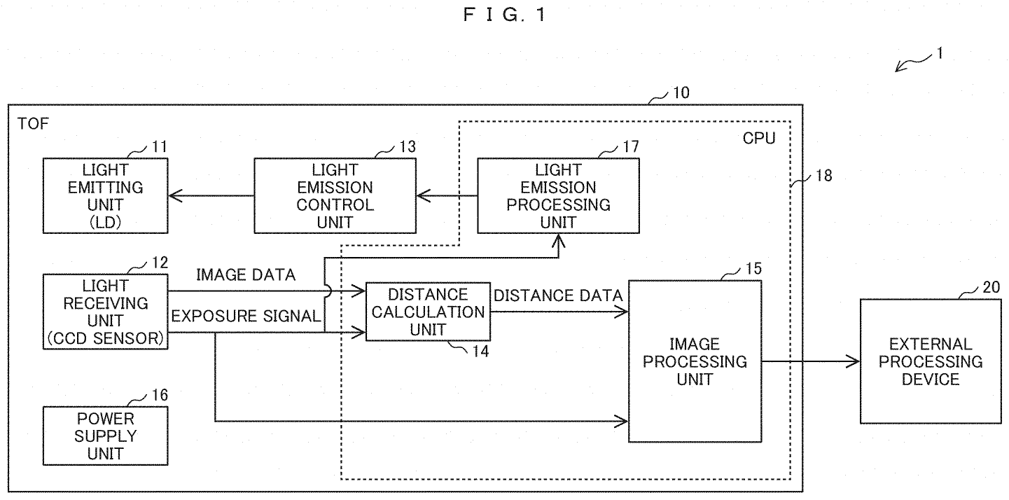

A distance measurement system 1 according to an embodiment will be described with reference to the drawings. FIG. 1 is a block diagram illustrating an example of a configuration of the distance measurement system.

As illustrated in FIG. 1, the distance measurement system 1 includes a TOF camera 10 (described as TOF in FIG. 1) and an external processing device 20. In addition, the TOF camera 10 and the external processing device 20 include interfaces (not illustrated), and the external processing device 20 can acquire data from the TOF camera 10.

First, the configuration of the TOF camera 10 will be described. The TOF camera 10 is a device (distance measurement device) that measures a distance on the basis of so-called time of flight (TOF). The TOF camera 10 includes a light emitting unit 11, a light receiving unit 12, a light emission control unit 13, a distance calculation unit 14, an image processing unit 15, and a power supply unit 16.

The light emitting unit 11 emits pulsed irradiation light emitted by a light source (a laser diode (LD) in the example illustrated in FIG. 1) such as an LD or a light emitting diode (LED). The light receiving unit 12 receives pulsed reflected light which has been reflected and returned, using an image sensor (a CCD in the example illustrated in FIG. 1, such as a CCD or a CMOS in which pixels are two-dimensionally arranged, and converts the pulsed reflected light into an electric signal.

The light emission control unit 13 has a light source driving circuit that turns on or off the light source or adjusts the amount of light emitted and can control the light source driving circuit in response to a command from a CPU 18 which will be described below. Then, the irradiation light from the light source is emitted to a region in which a subject is present.

The distance calculation unit 14 calculates the distance to the subject on the basis of the electric signal (described as image DATA in FIG. 1) of the image sensor output from the light receiving unit 12. The image processing unit 15 generates a distance image in which the distance to the subject is expressed in color on the basis of the calculated distance (described as distance DATA in FIG. 1) output from the distance calculation unit 14. For example, the image processing unit 15 can generate an image that becomes closer to red as the distance to the subject becomes shorter and becomes closer to blue as the distance to the subject becomes longer. In addition, it is possible to calculate a difference between the distances to each part of the subject, that is, an uneven shape of the subject from the deviation between the light receiving timings at each pixel position in the image sensor.

The power supply unit 16 has a configuration used to supply power. Power is supplied to the TOF camera 10 on the basis of an appropriate method. For example, power may be supplied to the TOF camera 10 by Power of Ethernet (PoE). In this case, the configuration of an interface is implemented by the power supply unit 16, and the TOF camera 10 and the external processing device 20 are connected by a LAN cable. In addition, power may be supplied to the TOF camera 10 by a power cord that is appropriately connected.

The distance calculation unit 14 and the image processing unit 15 are programs. In addition, the TOF camera 10 includes a light emission processing unit 17 which is a program used to control the light emission control unit 13. Then, the TOF camera 10 includes the CPU 18 that executes these programs (14, 15, and 17). Further, in this example, the CPU 18 is used as a processor that operates the programs. However, any device may be used as long as it performs a predetermined process, and other semiconductor devices may be used instead of the CPU 18. Furthermore, the TOF camera 10 may include an appropriate storage device (for example, a ROM) that stores data such as programs. In addition, the TOF camera 10 may include a RAM that temporarily stores data at the time of data processing.

In this embodiment, the TOF camera 10 performs measurement in units of frames, and the measurement is performed at a rate of, for example, 30 frames/sec on the basis of an exposure signal from the light receiving unit 12 which indicates exposure/non-exposure operations. Therefore, the operation timing of each unit (14, 15, and 17) is determined on the basis of the timing of the exposure signal of the light receiving unit 12. Here, the light emission processing unit 17 controls the light emission control unit 13 on the basis of the exposure signal to control a light emission period/a turn-off period of the light emitting unit 11. The distance calculation unit 14 calculates the distance on the basis of the exposure signal. The image processing unit 15 performs image processing on the basis of the exposure signal (or stops the image processing on the basis of the exposure signal).

Next, the external processing device 20 will be described. The external processing device 20 can be a general computer and includes a processor. The processor may perform a predetermined process and can be, for example, a CPU. However, the processor may be other semiconductor devices (for example, a GPU). In addition, the external processing device 20 may include a storage device, such as a ROM, that stores data. Further, the external processing device 20 may include a RAM that temporarily stores data at the time of data processing. In this embodiment, the processor of the external processing device 20 acquires data from the TOF camera 10, performs data processing which will be described in detail below, and corrects the distance measured by the TOF camera 10.

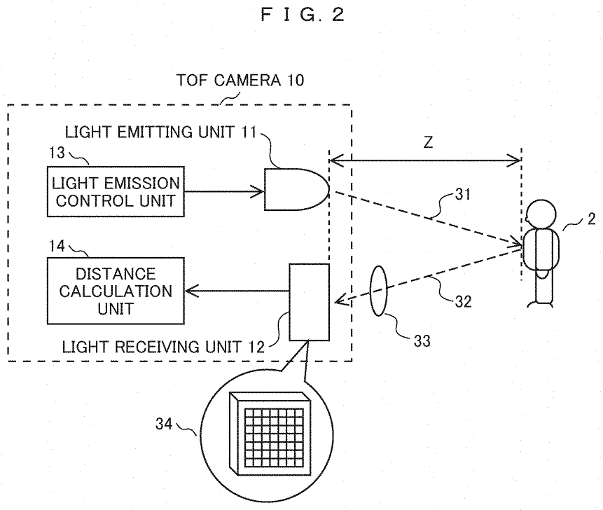

Next, the calculation of the distance by the TOF camera 10 will be described in more detail with reference to FIG. 2. FIG. 2 is a diagram illustrating an example of the calculation of the distance by the TOF camera.

As described above, the light emission control unit 13 controls the light emitting unit 11 such that a subject 2 (in this example, a person) is irradiated with an irradiation pulse 31 for distance measurement. Then, the irradiation pulse 31 is reflected by the subject 2 and becomes a reflected light pulse 32, and the light receiving unit 12 receives the reflected light pulse 32 through a lens 33. The light receiving unit 12 receives the reflected light 32 with an image sensor 34 that is a two-dimensional sensor, such as a CCD sensor, in which pixels are two-dimensionally arranged and converts the amount of exposure at each pixel position into an electric signal. The distance calculation unit 14 calculates a distance Z to the subject 2 from the electric signal of the light receiving unit 12 and generates two-dimensional distance data.

When a time difference from the emission of the irradiation pulse 31 by the light emitting unit 11 to the reception of the reflected light pulse 32 by the light receiving unit 12 is t, the distance Z to the subject 2 can be calculated as Z=c×t/2 (c is the light speed). Here, the time difference t can be calculated on the basis of a pulse width of the irradiation pulse 31 and the amount of charge detected by the image sensor 34 for a plurality of exposure periods.

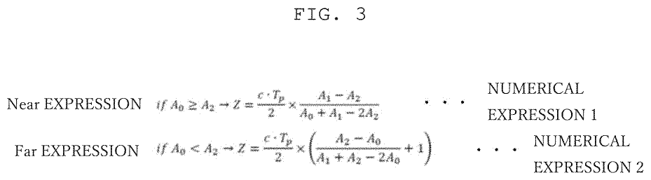

The distance Z to the subject 2 may be calculated by switching a plurality of numerical expressions according to conditions. For example, the distance Z can be calculated on the basis of Numerical Expression 1 and Numerical Expression 2 illustrated in FIG. 3.

Here, Numerical Expression 1 and Numerical Expression 2 are used in a case in which the exposure period is divided into three parts and exposure and measurement are performed. That is, in this example, the exposure is performed in the consecutive order of a first exposure period, a second exposure period, and a third exposure period. Then, the amount of charge measured for the first exposure period is represented by A₀, the amount of charge measured for the second exposure period is represented by A₁, and the amount of charge measured for the third exposure period is represented by A₂. In addition, in Numerical Expression 1 and Numerical Expression 2, Z is the distance, c is the light speed, and Tp is the pulse width of the irradiation pulse.

The switching conditions of Numerical Expression 1 and Numerical Expression 2 will be described. Focusing on the value of the amount of charge to be measured, Numerical Expression 1 (a first distance calculation expression which is referred to as a Near expression in some cases) is used to calculate the distance Z under the condition of A₀≥A₂. On the other hand, Numerical Expression 2 (a second distance calculation expression which is referred to as a Far expression in some cases) is used to calculate the distance Z under the condition of A₀<A₂.

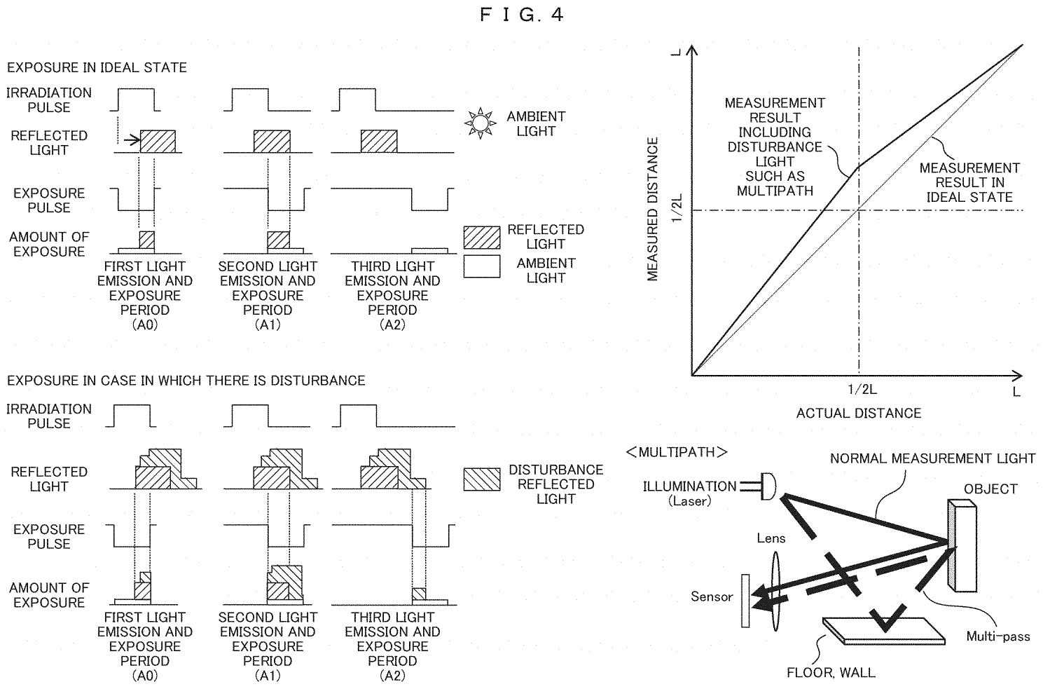

In an ideal state, Numerical Expression 1 and Numerical Expression 2 can be used to achieve high measurement accuracy, but a distance error occurs in an environment affected by multipath. Here, the difference in the measured distance between measurement in the ideal state and measurement including the influence of the multipath will be described with reference to FIG. 4.

First, the reception of the reflected light in the ideal state will be described. As in the case of the description of the above-mentioned Numerical Expression 1 and Numerical Expression 2, it is considered that the exposure period is divided into three parts and the reflected light is received at each timing. Here, the length of each of the three exposure periods is set to be equal to the length of the emission period (light emission period) of the emission pulse. Then, when the irradiation pulse is emitted and the reflected light is returned, a portion of the reflected light is received for the first exposure period, and the remaining reflected light is received for the second exposure period. In addition, in the example illustrated in FIG. 4, ambient light having the same intensity is received for each exposure period.

In this ideal state, the amounts of charge (A₀ to A₃) measured for each exposure period are used to acquire the measurement result with ensured linearity (in other words, with high accuracy) from Numerical Expression 1 and Numerical Expression 2 as illustrated in a graph of FIG. 4 (measurement result in the ideal state). However, when there is a disturbance caused by multipath, disturbance reflected light different from normal measurement light is received. Therefore, a difference in the value of the measured amount of charge occurs as compared with the case of the ideal state. In this case, as illustrated in the graph of FIG. 4 (the measurement result including disturbance light such as multipath), the above-described linearity is not ensured, and a measurement error occurs.

The influence of the multipath on the measured distance will be described with reference to the graph illustrated in FIG. 4. The measurement error caused by the multipath tends to increase as the measured distance increases. Then, the influence of the multipath tends to be reduced after a certain distance as a boundary. Here, in the measurement environment of the TOF camera 10, when the distance at which the influence of the multipath is reduced and substantially eliminated and thus the measurement error is substantially eliminated is L, the boundary distance at which the influence of the multipath starts to decrease is approximately ½ L (that is, 0.5 L).

Here, in the ideal state, when the above-described Numerical Expression 1 and Numerical Expression 2 are used, the amounts of charge satisfying the relationship of A₀=A₂ are measured at the position of ½ L, and the distance is measured. That is, the relationship of A₀=A₂ is established when ½ L is measured as the measured distance. Therefore, in the ideal state, for an actual distance of 0 to ½ L, an accurate measured distance can be calculated on the basis of Numerical Expression 1 (Near expression). In addition, for an actual distance of ½ L to L, an accurate measured distance can be calculated on the basis of Numerical Expression 2 (Far expression).

However, when there is an influence of the multipath, the distance error is included in the measured distance. Therefore, the position where the amounts of charge satisfying the relationship of A₀=A₂ are measured changes. For example, in the graph illustrated in FIG. 4, ½ L is measured as the measured distance at a position shorter than the actual distance of ½ L, and the amounts of charge satisfying the relationship of A₀=A₂ is measured at this timing. Therefore, the applicable range of the above-described Near expression and Far expression deviates from that in the ideal state, and the Near expression and the Far expression are not switched at the timing of the actual distance of ½ L.

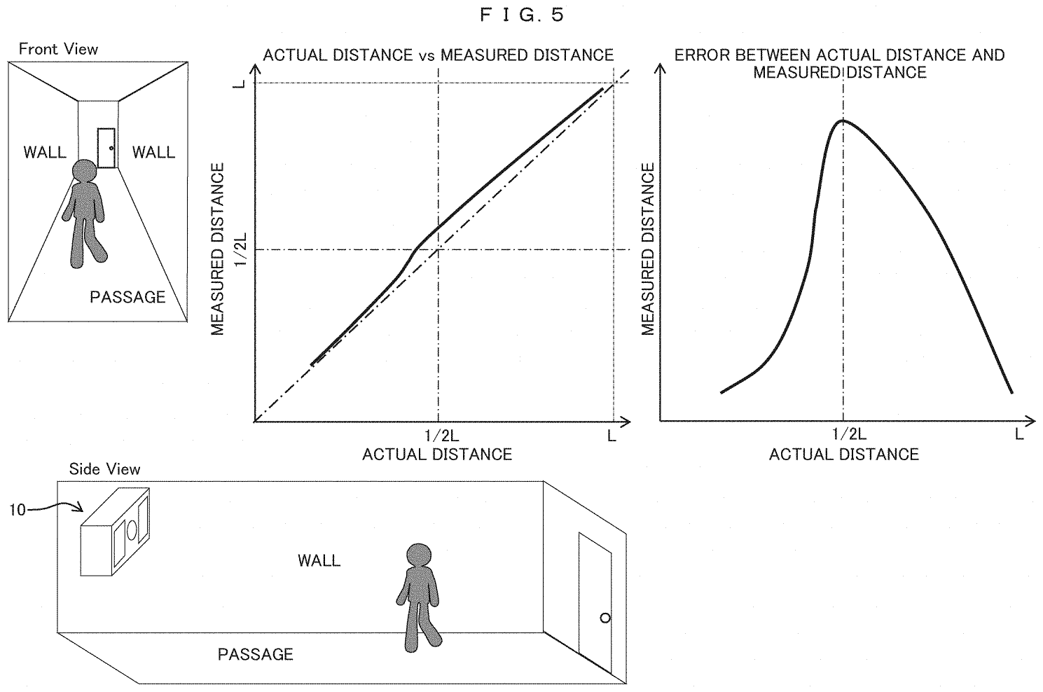

Next, an example of the influence of the multipath in a room will be described with reference to FIG. 5. As illustrated in FIG. 5, for example, the TOF camera 10 is installed on a ceiling of the room and measures a target area.

In a case in which the TOF camera 10 measures a subject in a narrow passage, a room, an elevator hall where a wall material having high light reflectance is used, or the like, a measurement error occurs due to the influence of the multipath as described above. That is, as illustrated in FIG. 5, the measurement error increases in the range of the measured distance from approximately 0 to ½ and decreases in the range of the measured distance from approximately ½ L to L.

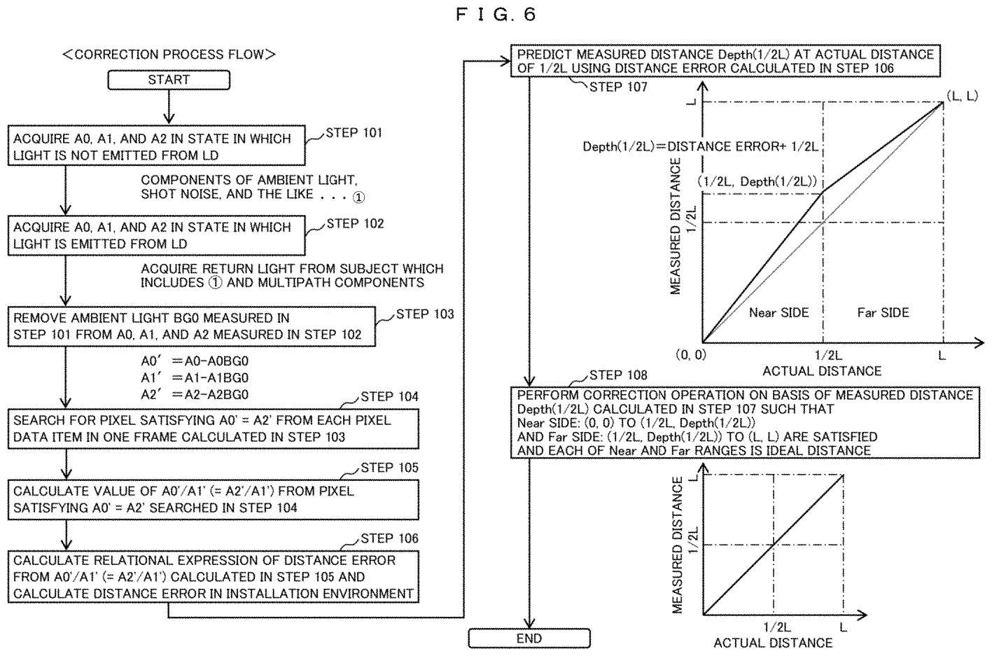

As described above, the accuracy of the measured distance is reduced by the influence of the multipath. Therefore, in this embodiment, a correction process flow illustrated in FIG. 6 is performed to correct the measured distance including the distance error caused by the influence of the multipath. In the distance measurement system 1 according to this embodiment, the processor of the external processing device 20 acquires data from the TOF camera 10 and performs the correction process flow. Here, the program used to perform the correction process flow may be executed by the processor of the external processing device 20 and is stored in, for example, the storage device included in the external processing device 20.

In the example of the correction process flow illustrated in FIG. 6, a correction expression for correcting a distance value is generated, and the correction operation is performed using this correction expression such that an ideal distance is obtained. The external processing device 20 acquires the amounts of charge (A₀, A₁, and A₂) measured in a state in which the light source (the LD in the example of FIG. 6) does not emit light from the TOF camera 10 when the correction expression is generated (Step 101). That is, in Step 101, components of, for example, ambient light and shot noise in the measurement environment are acquired.

In addition, the external processing device 20 acquires the amounts of charge (A₀, A₁, and A₂) measured in a state in which the light source emits light from the TOF camera 10 (Step 102). That is, in Step 102, the components acquired in Step 101 and components of the reflected light, which has been reflected by the subject and returned, are acquired. Here, the components of the reflected light include multipath components in the measurement environment. In addition, Step 101 and Step 102 may be performed before Step 103 which will be described below, and the timing when Step 101 and Step 102 are performed may be appropriately changed.

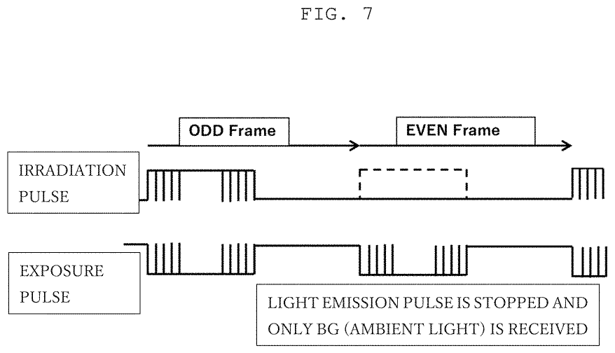

Here, an example of a method for acquiring the amounts of charge (A₀, A₁, A₂) in Step 101 and Step 102 will be described with reference to FIG. 7. FIG. 7 is a diagram illustrating an example of the method for acquiring the amounts of charge.

In general, the distance is measured by repeating a plurality of frames including both the light emission period and the exposure period. However, in this example, a frame including both the light emission period and the exposure period (described as an odd-numbered frame in FIG. 7) and a frame that includes the exposure period and does not include the light emission period (described as an even-numbered frame in FIG. 7) are alternately set. Then, the TOF camera 10 performs measurement on the basis of the set frames. Here, in the frame that does not include the light emission period and includes the exposure period, only the components of the ambient light are received, and it is considered that the components of the ambient light and the like received in this frame correspond to, for example, the components of the ambient light and the like received in the previous frame (the previous odd-numbered frame in FIG. 7).

In this embodiment, the components described in Step 101 and the components described in Step 102 are acquired on the basis of the frames that have been set alternately in this way. That is, the components described in Step 101 are acquired on the basis of the frame that does not include the light emission period and includes the exposure period, and the components described in Step 102 are acquired on the basis of the frame that includes both the light emission period and the exposure period. In addition, the example in which the frames are alternately set has been described above. Any configuration may be used as long as the components of the ambient light in the measurement environment are appropriately acquired. For example, the cycle of the frame that does not include the light emission period and includes the exposure period may be appropriately changed in consideration of the actual measurement environment.

After Step 101 and Step 102, the components (that is, the amounts of charge A₀, A₁, and A₂ measured in Step 102) acquired in Step 101 are removed from the components acquired in Step 102 (that is, the amounts of charge A₀, A₁, and A₂ related to ambient light BG) measured in Step 102 (Step 103). In Step 103, the components of the ambient light are subtracted to be removed, and components of the reflected light including the influence of the multipath (that is, the amounts of charge A₀′, A₁′, and A₂′ from which the components of the ambient light have been removed) are acquired.

Then, a pixel for which A₀′=A₂′ is established is searched from each pixel (each pixel of the image sensor 34) in one frame calculated in Step 103 (Step 104). That is, the pixel for which the calculation expressions of the Near expression and the Far expression are switched is picked up.

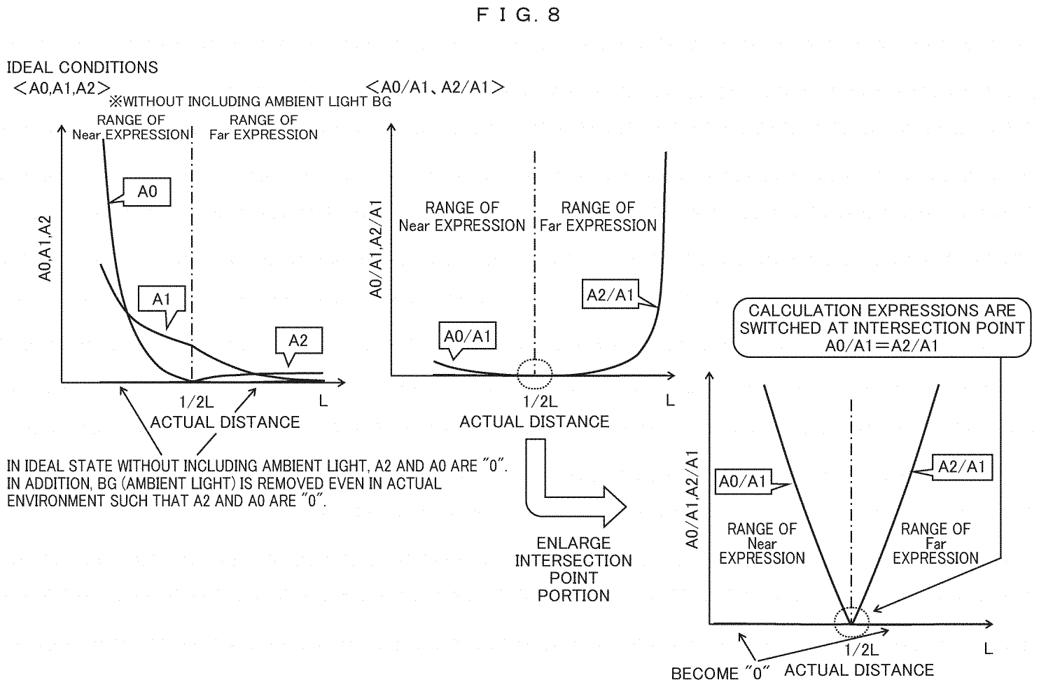

Then, the value of A₀′/A₁′ and the value of A₂′/A₁′ are calculated from the pixel for which A₀′=A₂′ is established and which has been searched in Step 104, and the value of A₀′/A₁′ (=A₂′/A₁′) is calculated (Step 105). Here, the meaning of the radio between the amounts of charge will be described with reference to FIG. 8. FIG. 8 is a diagram illustrating the ratio between the amounts of charge under the ideal conditions.

In a state in which the multipath and the ambient light are not included (ideal state), the amount of charge A₀ is zero and the amount of charge A₂ is measured on the basis of the position of ½ L. That is, the relationship of A₀=A₂ is established at the position of ½ L, and the applicable range of the Near expression and the Far expression is switched on the basis of this position.

Focusing on the ratio between the amounts of charge at this time, A₀/A₁ is greater than 0 within the applicable range of the Near expression and is 0 out of the applicable range of the Near expression. Similarly, A₂/A₁ is greater than 0 within the applicable range of the Far expression and is 0 out of the applicable range of the Far expression. Then, the values of these ratios are equal to each other at the switching position (that is, the position of ½ L) of the calculation expression (that is, A₀/A₁=A₂/A₁ is established).

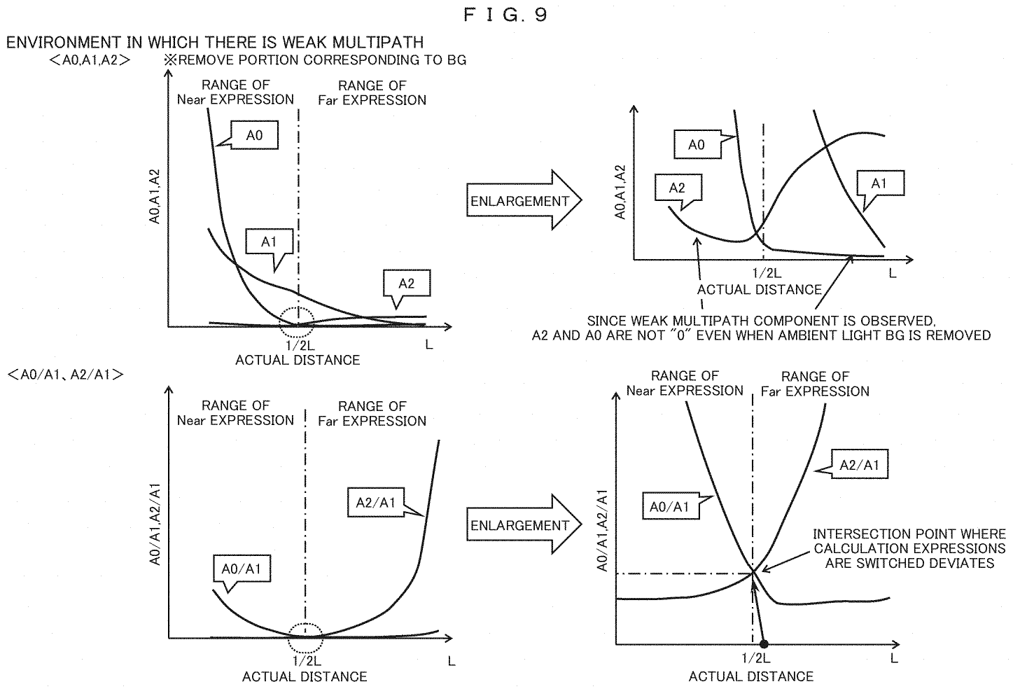

Then, a case in which the influence of the multipath is small unlike the ideal conditions will be described. FIG. 9 is a diagram illustrating the ratio between the amounts of charge in a case in which the influence of the multipath is small.

As illustrated in FIG. 9, in a state in which the influence of the multipath is small and the ambient light is not included, the measured amount of charge is different from that in the case of the ideal conditions, and the amounts of charge A₀ and A₂ are zero. Then, the position where the values of A₀/A₁ and A₂/A₁ are equal to each other deviates from the position of ½ L. Therefore, the position where the Near expression and the Far expression are switched (that is, the position where A₀/A₁=A₂/A₁) deviates from the position of ½ L.

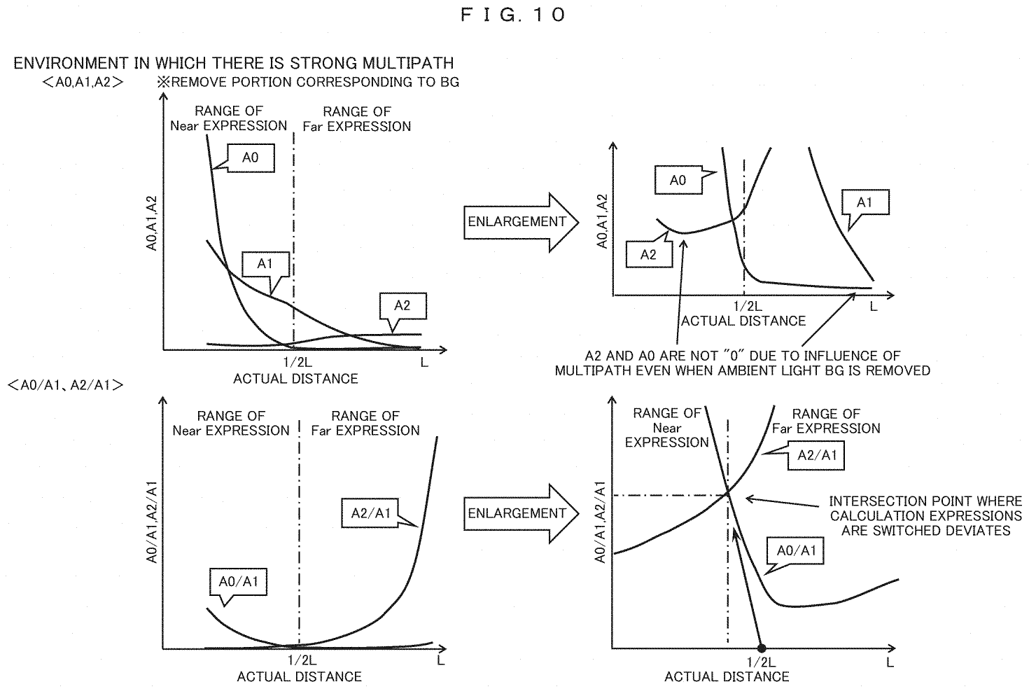

Next, a case in which the influence of the multipath is large unlike the ideal conditions will be described. FIG. 10 is a diagram illustrating the ratio between the amounts of charge in a case in which the influence of the multipath is large.

As illustrated in FIG. 10, in a state in which the influence of the multipath is large and the ambient light is not included, the measured amount of charge is different from that in the case of the ideal conditions, and the amounts of charge A₀ and A₂ are not zero. In addition, the position where the values of A₀/A₁ and A₂/A₁ are equal to each other (that is, the position where the Near expression and the Far expression are switched) largely deviates from that in a case in which the influence of the multipath is small.

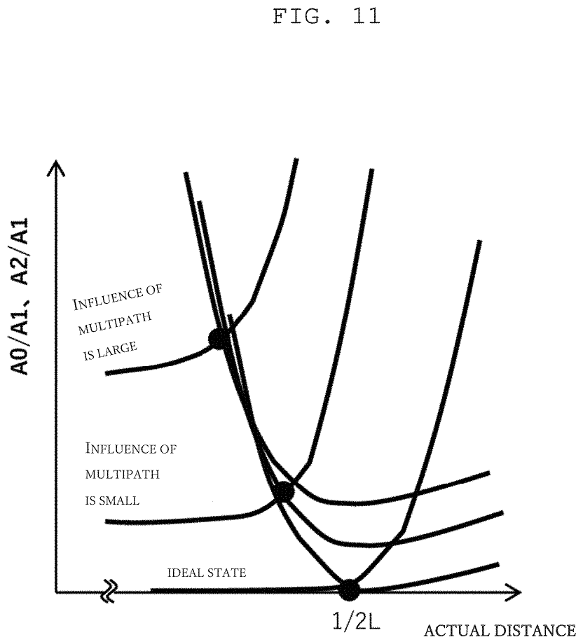

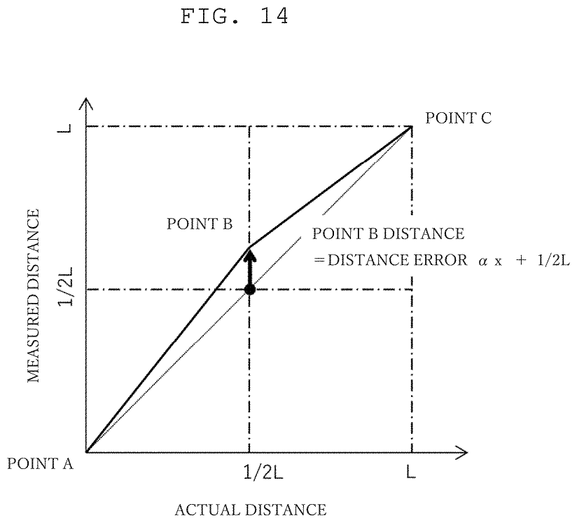

In a case in which the value of A₀′/A₁′ (=A₂′/A₁′) is calculated in Step 105, the relational expression of the distance error is calculated. Then, the distance error at the actual distance of ½ L is calculated from the relational expression of the distance error (Step 106). Then, a method for calculating the relational expression of the distance error will be described with reference to FIGS. 11 to 13. In addition, the distance error at the position of ½ L will be described with reference to FIG. 14. FIGS. 11 to 13 are diagrams illustrating an example of the method for calculating the relational expression of the distance error. FIG. 14 is a diagram illustrating the distance error at the position of ½ L.

A graph illustrated in FIG. 11 shows the relationship between the ratios between the amounts of charge in the above-described ideal state and a state in which there is an influence of the multipath. As described above, in the ideal state, the point where the Near expression and the Far expression are switched (that is, the point where A₀′/A₁′=A₂′/A₁′ is established) is the position of ½ L. However, this point where the calculation expressions are switched deviates from ½ L due to the influence of the multipath, and the degree of deviation becomes larger as the influence of the multipath becomes larger. Therefore, the strength of the influence of the multipath in the measurement environment is evaluated from the magnitude of the ratio between the amounts of charge acquired in Step 105 on the basis of the relationship between the ratios between the amounts of charge (that is, the characteristics that the degree of deviation from ½ L becomes smaller as the influence of the multipath becomes smaller and the degree of deviation from ½ L becomes larger as the influence of the multipath becomes larger).

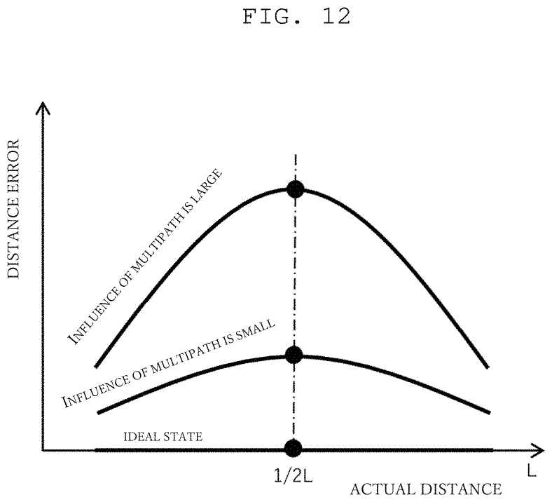

A graph illustrated in FIG. 12 shows the relationship between the actual distance and the distance error caused by the influence of the multipath. That is, as described above, the distance error caused by the influence of the multipath is maximum at the position of ½ L, and the influence of the multipath is reduced from the position of ½ L as a boundary. Therefore, the distance error at the position where the actual distance is ½ L (in other words, the maximum distance error) is calculated on the basis of the evaluated strength of the influence of the multipath which has been described above and data indicating the relationship between the actual distance and the distance error caused by the influence of the multipath. In addition, the data indicating the relationship between the actual distance and the distance error caused by the influence of the multipath (for example, data related to the graph illustrated in FIG. 12) may be prepared in advance such that it can be used in the correction process flow.

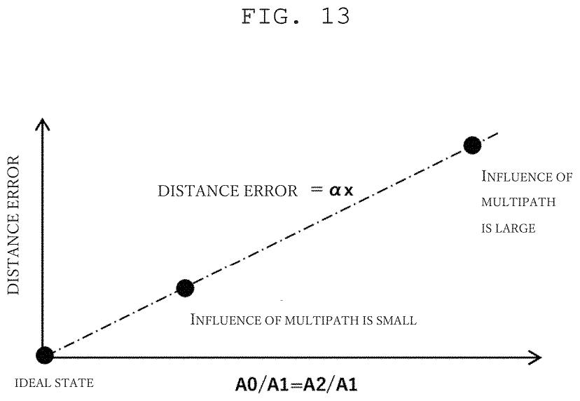

Then, a relational expression of the distance error that summarizes the relationship between the magnitude of the ratio between the amounts of charge acquired in Step 105 and the distance error at the position of ½ L is generated. For example, the relational expression of the distance error can be represented by αx (α is a coefficient) as illustrated in FIG. 13. However, any appropriate relational expression may be used. For example, the relational expression may be a linear expression or a polynomial expression. The relational expression of the distance error may be calculated on the basis of the ratio between the actually measured amounts of charge acquired by the method in Steps 101 to 105. In addition, the magnitude of the ratio between the amounts of charge excluding the influence of the ambient light may be predicted by the same method as that in Steps 101 to 105, and the relational expression of the distance error may be calculated by a simulation using the predicted magnitude of the ratio between the amounts of charge.

In Step 106, as illustrated in FIG. 14, a distance error related to a point B is calculated, using the relational expression of the distance error, on the basis of the magnitude of the ratio between the amounts of charge acquired in the actual measurement environment (that is, the magnitude of the ratio between the amounts of charge acquired in Steps 101 to 105). Here, the point B is a point indicating the measured distance at the actual distance of ½ L, and this measured distance (a point B distance in FIG. 14) can be considered as a distance error αx+½ L. In addition, on the graph, a point A corresponds to (0, 0), and a point C corresponds to (L, L).

In a case in which the distance error of the point B is calculated in Step 106, the measured distance at the point B is predicted (Step 107). That is, a measured distance (described as Depth(½ L) in FIG. 6) obtained by adding the distance error to the measured distance (that is, ½ L) in the ideal state is predicted. In addition, the measured distance at the point B may be appropriately predicted using the distance error. For example, the measured distance may be predicted by the following method. That is, a range from 0 to L may be preset as a distance measurement range. A value of ½ L may be calculated from this set data, the distance error may be added to this value, and the measured distance at the point B may be predicted.

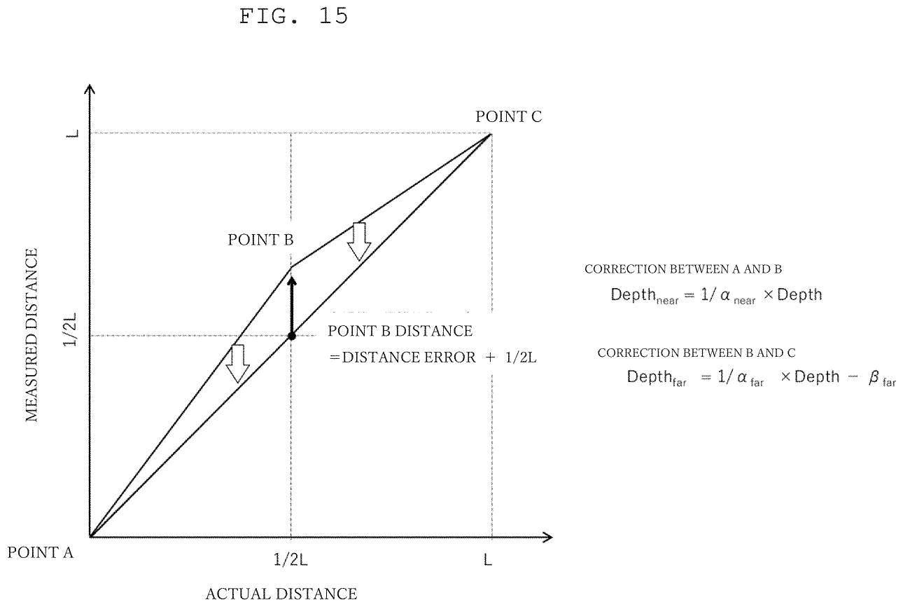

In a case in which the measured distance at the point B is predicted, a correction expression that corrects the influence of the multipath is generated. Then, a correction operation is performed such that the Near side (the range from the actual distance of 0 to ½ L) and the Far side (the range from the actual distance of ½ L to L) approach the ideal values (Step 108). First, an example of how to calculate the correction expression will be described with reference to FIG. 15.

In this example, a correction expression is calculated which brings the Near-side measured distance (corresponding between A and B in FIG. 15), which is calculated including the measurement error caused by the influence of the multipath, close to a straight line in the ideal state. That is, when the distance of the point B is estimated, it is possible to calculate a correction parameter between A and B. Therefore, the correction expression between A and B can be calculated on the basis of this correction parameter. In this example, the correction expression that brings the measured distance close to the ideal state is calculated on the basis of a correction coefficient αₙₑₐᵣ near which is a correction parameter corresponding to the inclination between A and B. Here, Depthₙₑₐᵣ indicates the measured distance in the ideal state, and Depth indicates the measured distance between A and B.

Similarly, a correction expression is calculated which brings the Far-side measured distance (corresponding between B and C in FIG. 15), which is calculated including the measurement error caused by the influence of the multipath, close to a straight line in the ideal state. That is, when the distance of the point B is estimated, it is possible to calculate a correction parameter between B and C. Therefore, a correction expression between B and C can be calculated on the basis of this correction parameter. In this example, the correction expression that brings the measured distance close to the ideal state is calculated on the basis of a correction coefficient α_{far} which is a correction parameter corresponding to the inclination between B and C and a correction coefficient β_{far} which is a correction parameter for adjusting the value of an intercept between B and C. Here, Depth_{far} indicates the measured distance in the ideal state, and Depth indicates the measured distance between B and C.

In this way, in Step 108, the correction expressions for correcting the Near-side and Far-side measured distances are generated. Then, the correction operation is performed on the measured distance measured by the TOF camera 10 such that the Near-side measured distance, that is, the measured distance from a point A (0, 0) to the point B (½ L, Depth(½ L)) is ideal. In addition, the correction operation is performed on the measured distance measured by the TOF camera 10 such that the measured distance from the point B (½ L, Depth(½ L)) to a point C (L, L) is ideal.

Here, in a case in which the measured distance to be corrected is shorter than the B point distance (or is equal to or shorter than the B point distance) in the correction of the measured distance, a Near-side correction expression is used. In a case in which the measured distance to be corrected is longer than the B point distance (or is equal to or longer than the B point distance), a Far-side correction expression is used. In a case in which the measured distance to be corrected is equal to the point B distance, any correction expression may be used. Further, according to the correction process flow of this embodiment, the processor of the external processing device 20 can perform the correction operation on the measured distance acquired from each pixel of the image sensor 34 using the generated correction expression. Furthermore, in the example illustrated in FIG. 15, an example in which a linear correction expression is generated has been described. However, any correction operation may be performed as long as it brings the measured distance appropriately close to the straight line of the ideal value, and a polynomial correction expression may be generated.

According to this correction process flow, appropriate correction can be performed to correct the measured distance even in a case in which the applicable range of the Near expression and the Far expression deviates from the ideal state due to the influence of the multipath and the Near expression and the Far expression are not switched at the timing of the actual distance of ½ L.

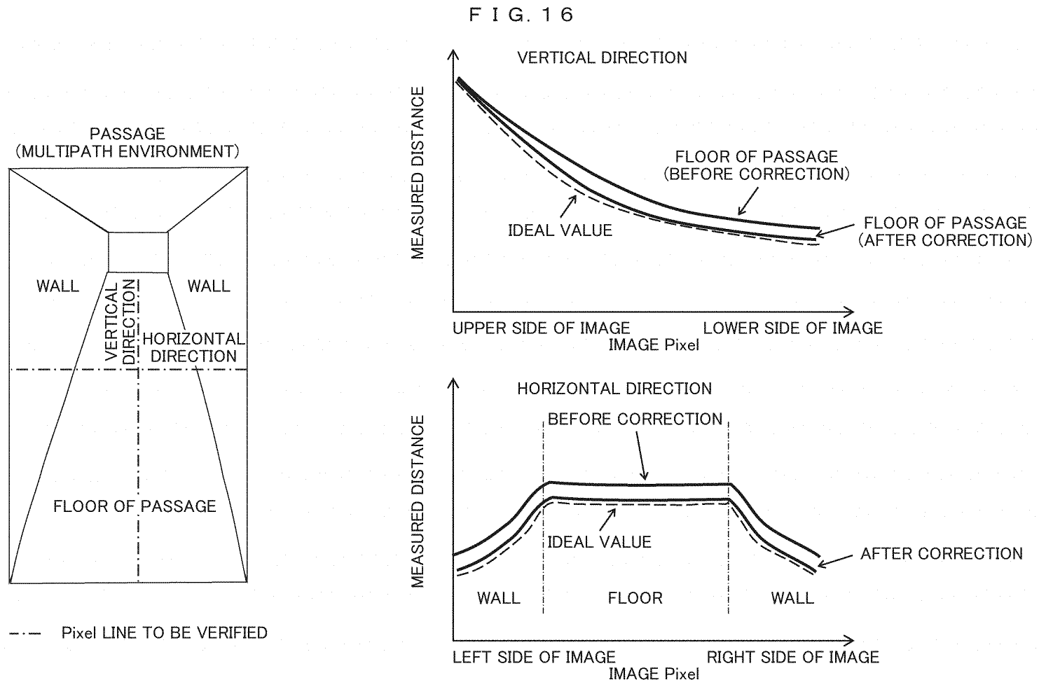

Next, an example of the effect of the correction operation will be described with reference to FIG. 16. FIG. 16 is a diagram illustrating an example of the effect of the correction operation.

In the example illustrated in FIG. 16, the TOF camera 10 is installed indoors, and measurement is performed in a passage. In this measurement environment, it is considered that multipath occurs due to walls and floors. Then, the measured distance to a portion indicated by a chain line in an image (an image of distance data) deviates from an ideal value due to the influence of the multipath, as illustrated in a graph showing the relationship between the measured distances in the vertical direction and a graph showing the relationship between the measured distances in the horizontal direction. Here, since the measured distance is corrected on the basis of the above-described correction operation in Step 108, the distance error caused by the influence of the multipath is suppressed, and the measurement error is reduced.

A method has been described above which improves the distance calculation error caused by the multipath, using the distance calculation method, which uses A₀, A₁, and A₂ respectively measured for the first exposure period, the second exposure period, and the third exposure period that are divided from the exposure period and two calculation expressions (the Near expression and the Far expression) that are switched according to the conditions of each of the measured amounts of charge, as an example.

That is, the strength of the influence of the multipath in the measurement environment is evaluated from the magnitude of the value of each ratio between the amounts of charge (for example, the value at which the value of A₀/A₁ is equal to the value of A₂/A₁) used to calculate the distance at the position where the distance calculation expressions are switched (that is, in a case in which there is no influence of the multipath, the position where the ideal distance is clear and the position corresponding to ½ L in the above description).

The relationship between the value of the ratio between the amounts of charge at the position where the distance calculation expressions are switched and the distance error caused by the influence of the multipath is calculated to generate the relational expression of the distance error as illustrated in FIG. 13.

The distance error related to the position where the distance calculation expressions are switched (that is, the position where the ideal distance is clear in a case in which there is no influence of the multipath) is calculated on the basis of the magnitude of the ratio between the amounts of charge acquired in the actual measurement environment, using the relational expression of the distance error.

As described above, the distance error at the position where the ideal distance is clear is calculated. Therefore, as described above, it is possible to calculate the correction expression such that the distance is close to the ideal value of the measured distance in the ideal state and to perform the correction operation. The measured distance is corrected on the basis of these processes. Therefore, the influence of the multipath is suppressed, and the measurement error is reduced.

Further, the distance calculation method using three exposure periods and two calculation expressions has been described as an example. However, the invention is not limited to the distance calculation method using three exposure periods and two calculation expressions. It is not difficult to conceive that the invention can be applied to a distance calculation method using a plurality of exposure periods more than three exposure periods and a plurality of calculation expressions more than two calculation expressions.

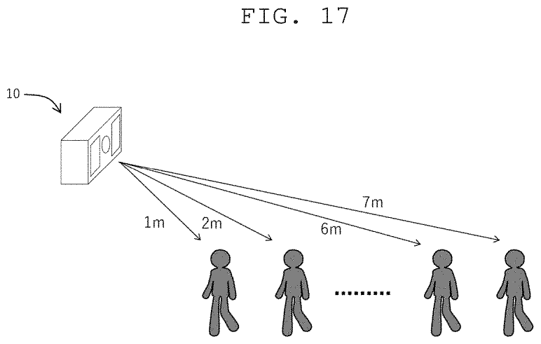

In addition, a method is considered which calculates a correction coefficient or the like from the correlation between the actual distance and the measured distance at a plurality of points (a plurality of different distance positions) and calculates a correction expression. For example, a method is considered in which subjects are actually positioned every 1 m, a correction coefficient or the like is calculated on the basis of a correlation with the measured distance acquired from the subjects positioned every 1 m, and a correction expression is calculated, as illustrated in FIG. 17. However, it is considered that this method requires measurement at distance positions of a plurality of points and it is difficult to achieve a flexible operation. For example, in a case in which a plurality of TOF cameras 10 are installed, an adjustment time for each TOF camera is required, and a large amount of time is required to adjust the plurality of TOF cameras. In contrast, according to this embodiment, a measurement error prediction algorithm is provided, and the correction process flow is performed to generate the correction expression. Therefore, it is possible to achieve a flexible operation.

The invention is not limited to the above-described embodiment and includes various modification examples. For example, the embodiment has been described in detail for a better understanding of the invention, and the invention is not necessarily limited to the embodiment including all of the described configurations.

The corrected distance data may be used, for example, for movement trace for a person, people counting, or the like. Therefore, a high-accuracy process with a reduced measurement error is achieved. In addition, for example, an appropriate processor executes an application to achieve the movement trace and the people counting. Here, the external processing device 20 may perform a process in cooperation with this application and a program used to perform the correction process flow.

The external processing device 20 may appropriately perform data processing, such as the correction process flow, and the data used for the data processing may be stored in an external storage device connected to the external processing device 20. Then, the external processing device 20 may acquire data from the external storage device and perform a process. Further, the external processing device 20 may be disposed at the same installation position as the TOF camera 10 or may be disposed at a remote location different from the installation position of the TOF camera 10. The external processing device 20 may acquire data using wired communication or may acquire data using wireless communication.

In this embodiment, the system has been described in which the program used to perform the correction process flow is executed by the external processing device 20 and the external processing device 20 performs the correction processing flow. However, the TOF camera 10 may execute the program used to perform the correction process flow and output the corrected measured distance. In this case, the external processing device 20 is omitted. Then, for example, the program used to perform the correction process flow may be stored in the storage device of the TOF camera 10, and the processor (for example, the CPU 18) of the TOF camera 10 may execute this program. Therefore, the TOF camera 10 (distance measurement device) is provided which can check the influence of the multipath, correct the distance for each pixel to suppress the error from the actual distance, and improve the accuracy of the distance.

What is claimed is:

1. A distance measurement system comprising:
a distance measurement device that receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period; and
an external processing device that acquires the measured distance from the distance measurement device and performs data processing,
wherein the external processing device predicts a measured distance including a distance error caused by an influence of multipath, generates a correction expression for correcting the measured distance, and corrects the measured distance acquired from the distance measurement device using the correction expression.

2. The distance measurement system according to claim 1,
wherein the distance measurement device separately receives the reflected light for a first exposure period for which an amount of charge A₀ is measured, a second exposure period for which an amount of charge A₁ is measured, and a third exposure period for which an amount of charge A₂ is measured in a frame which has a plurality of consecutive exposure periods of the first exposure period, the second exposure period, and the third exposure period and in which the irradiation light is emitted, and
the external processing device calculates a relational expression of the distance error when a value of A₀/A₁ is equal to a value of A₂/A₁ and calculates the distance error caused by the influence of the multipath using the relational expression of the distance error.

3. The distance measurement system according to claim 2,
wherein the external processing device generates, as the correction expression, a correction expression for correcting a measured distance from an actual distance of 0 to ½ L and a correction expression for correcting a measured distance from an actual distance of ½ L to L on the basis of the predicted measured distance (where L is an actual distance at which the influence of the multipath is substantially eliminated).

4. The distance measurement system according to claim 3,
wherein the distance measurement device calculates a distance using a first distance calculation expression and a second distance calculation expression switched when A₀=A₂ is established.

5. The distance measurement system according to claim 1,
wherein the distance measurement device performs measurement on the basis of a frame in which the irradiation light is emitted and the reflected light is received and a frame in which the irradiation light is not emitted and ambient light is received, and
the external processing device acquires information of the amount of charge measured in each frame when the correction expression is generated and subtracts the amount of charge measured in the frame in which the irradiation light is not emitted and the ambient light is received to remove an influence of the ambient light from the reflected light.

6. A distance measurement device that receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period,
wherein the distance measurement device predicts a measured distance including a distance error caused by an influence of multipath, generates a correction expression for correcting the measured distance, and corrects the measured distance using the correction expression.

7. The distance measurement device according to claim 6,
wherein the distance measurement device separately receives the reflected light for a first exposure period for which an amount of charge A₀ is measured, a second exposure period for which an amount of charge A₁ is measured, and a third exposure period for which an amount of charge A₂ is measured in a frame which has a plurality of consecutive exposure periods of the first exposure period, the second exposure period, and the third exposure period and in which the irradiation light is emitted,
calculates a relational expression of the distance error when a value of A₀/A₁ is equal to a value of A₂/A₁, and
calculates the distance error caused by the influence of the multipath using the relational expression of the distance error.

8. The distance measurement device according to claim 7,
wherein the distance measurement device generates, as the correction expression, a correction expression for correcting a measured distance from an actual distance of 0 to ½ L and a correction expression for correcting a measured distance from an actual distance of ½ L to L on the basis of the predicted measured distance (where L is an actual distance at which the influence of the multipath is substantially eliminated).

9. The distance measurement device according to claim 8,
wherein the distance measurement device calculates a distance using a first distance calculation expression and a second distance calculation expression switched when A₀=A₂ is established.

10. The distance measurement device according to claim 6,
wherein the distance measurement device performs measurement on the basis of a frame in which the irradiation light is emitted and the reflected light is received and a frame in which the irradiation light is not emitted and ambient light is received, and
subtracts the amount of charge measured in the frame in which the irradiation light is not emitted and the ambient light is received to remove an influence of the ambient light from the reflected light when the correction expression is generated.

11. A distance measurement method using a distance measurement device that receives reflected light from a subject for a plurality of exposure periods in a frame in which irradiation light is emitted, switches a plurality of distance calculation expressions according to an amount of charge measured for each exposure period, and calculates a measured distance to the subject from the amount of charge measured for each exposure period, the distance measurement method comprising:
predicting a measured distance including a distance error caused by an influence of multipath;
generating a correction expression for correcting the measured distance; and
correcting the measured distance using the correction expression.

12. The distance measurement method according to claim 11,
wherein the reflected light is separately received for a first exposure period for which an amount of charge A₀ is measured, a second exposure period for which an amount of charge A₁ is measured, and a third exposure period for which an amount of charge A₂ is measured in a frame which has a plurality of consecutive exposure periods of the first exposure period, the second exposure period, and the third exposure period and in which the irradiation light is emitted,
a relational expression of the distance error when a value of A₀/A₁ is equal to a value of A₂/A₁ is calculated, and
the distance error caused by the influence of the multipath is calculated using the relational expression of the distance error.

13. The distance measurement method according to claim 12,
wherein, as the correction expression, a correction expression for correcting a measured distance from an actual distance of 0 to ½ L and a correction expression for correcting a measured distance from an actual distance of ½ L to L are generated on the basis of the predicted measured distance (where L is an actual distance at which the influence of the multipath is substantially eliminated).

14. The distance measurement method according to claim 13,
wherein a distance is calculated using a first distance calculation expression and a second distance calculation expression switched when A₀=A₂ is established.

15. The distance measurement method according to claim 11,
wherein measurement is performed on the basis of a frame in which the irradiation light is emitted and the reflected light is received and a frame in which the irradiation light is not emitted and ambient light is received, and
the amount of charge measured in the frame in which the irradiation light is not emitted and the ambient light is received is subtracted to remove an influence of the ambient light from the reflected light when the correction expression is generated.
